(19) United States
(12) Patent Application Publication
(10) Pub. No.: US 2007/0150491 A1
(43) Pub. Date: Jun. 28, 2007

(54) Server middleware for enterprise work group presence solution

(76) Inventor: Marko Torvinen, Espoo (FI)

Correspondence Address: MORGAN & FINNEGAN, LLP, 3 World Financial Center, New York, NY, 10281-2101, US

(21) Appl. No.: 11/318,580

(22) Filed: Dec. 28, 2005

(51) Int. Cl. G06F 7/00

(52) U.S. Cl. 707/100

(57) ABSTRACT

An apparatus, system, method and computer product and medium are provided to implement operations of defining a group presence profile for a group of individual entities, the group presence profile having group attributes associated therewith; obtaining presence information for the individual entities of the group; and managing presence information for the group according to the defined group presence profile and the presence information of the individual entities.

### FIELD OF THE INVENTION

The present invention relates to presence technology and, more particularly, to a software layer or server middleware application to provide group presence environment and to facilitate provision of services to groups.

### BACKGROUND

The current presence technologies and environments are generally configured and directed to provide presence on “individual” entities, e.g., a particular person or user, through a user's device such as a mobile terminal. However, there is currently no solution to address presence on a group level and to provide services or applications on a group level which may be efficiently or effectively integrated to utilize group presence environment. The concept of group presence would be of particular use to enhance work efficiencies of work groups in an enterprise or corporate setting.

### SUMMARY

An apparatus, system, method and computer product and medium are provided to implement the operations of defining a group presence profile for a group of individual entities, the group presence profile having group attributes associated therewith; obtaining presence information for the individual entities of the group; and managing presence information for the group according to the defined group presence profile and the presence information of the individual entities. These operations may be implemented through a server middleware application program, and an application program interface (API) may be provided to allow external application(s) to access the server middleware application program or presence information. The individual entities may correspond to people in an organization.

In various aspect, the presence information for the group may be shared with the individual entities of the group according to the defined group presence profile. The presence information may include one or more viewpoints of information accessible according to an authorization level of a viewing entity.

The apparatus, system, method and computer product and medium maybe provided to implement further operations of enabling an external entity to access the presence information of the group; providing the group presence profile and corresponding attributes to a communications device of an individual entity of the group; providing an application program to a device operated by an individual entity of the group, the application program when executed enables the device to perform the managing operation; updating one or more attributes of the group presence profile; managing one or more services provided to the group according to the presence information of the group, the one or more services comprising for example distribution of information within the group; and/or managing communications of information within the group according to the defined group presence profile or presence information of the group.

In another aspect, the managing of presence information for the group may involve generating or updating the presence information for the group according to the accessed presence information of the individual entities and respective defined group presence profile; or generating or updating the presence information for the group according to update information provided by a member of the group.

In yet another aspect, the attributes of the group presence profile may define one or more categories of presence information to be obtained for the group. The one or more categories of presence information may include at least an availability status of the group.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a block diagram of an exemplary operational environment in accordance with an embodiment;

FIG. 2 is a block diagram of an exemplary configuration in which group presence application or system is implemented across two or more servers in accordance with an embodiment;

FIG. 3 is a block diagram of an exemplary configuration in which group presence application or system is implemented on a server in accordance with an embodiment;

FIG. 4 is a flow diagram of exemplary operations performed by the systems, servers and devices shown in FIG. 1 in accordance with an embodiment;

FIG. 5 is a block diagram showing exemplary components of a communications device in accordance with an embodiment;

FIG. 6 is a block diagram showing exemplary components of a server or system, such as a presence servers and device management system shown in FIG. 1, in accordance with an embodiment;

FIG. 7 is a block diagram showing exemplary components of a management system in accordance with an embodiment;

FIGS. 8 and 9 show exemplary screen shots of exemplary information provided on a communications device of a group member or entity through a group presence environment in accordance with an embodiment;

FIG. 10 is a flow diagram of an exemplary process to define group presence entity profile (or instance) in accordance with an embodiment;

FIG. 11 is a flow diagram of an exemplary process to manage services in a group presence environment in accordance with an embodiment;

FIG. 12 is a flow diagram of an exemplary process to manage presence information for one or groups in accordance with an embodiment; and

FIG. 13 is a flow diagram of an exemplary process to manage group information or services for one or more groups in accordance with an embodiment.

### DETAILED DESCRIPTION OF THE VARIOUS EMBODIMENTS

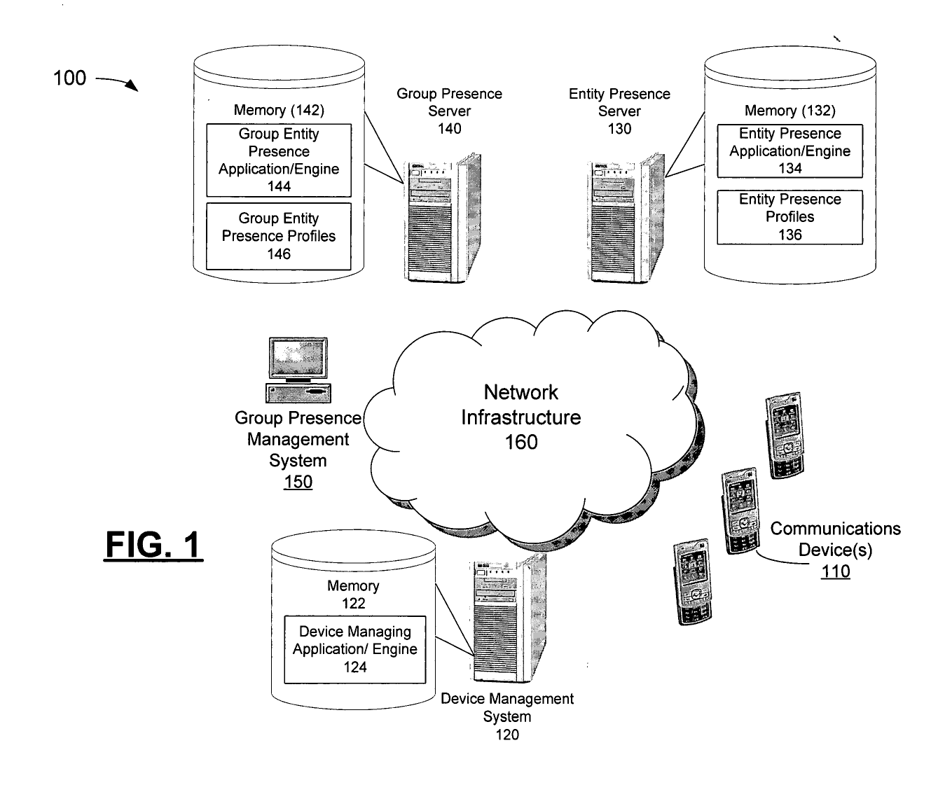

FIG. 1 is a block diagram of an exemplary network environment 100 in accordance with an embodiment. In this example, the network environment 100 includes one or more communications devices 110 associated with one or more entities (e.g., a user or person), device management system 120, entity presence server 130, a group presence server 140 and a group presence management system 150. A network infrastructure 160 is provided between the system, servers and devices enable communications therebetween. The network infrastructure 160 may include one or more networks and network components, such as an Intranet (e.g., corporate network), Internet, mobile or wireless network, and so forth.

The device management system 120 may be a computer or processor based system, such as a server or the like, which includes a memory 122 storing a device managing application or engine 124 for managing or facilitating operations or functionality of one or more communications device 110. These operations may involve updating or downloading applications, files or data to a communications device 110.

The communications device(s) 110 may be a mobile device such as a cell phone, personal digital assistant (PDA) and so forth. The communications device(s) 110 may be configured to transmit presence update information for an individual entity as well as update information for a group, and to receive presence information for individuals or groups or individual or group services.

The entity presence server 130 may be a computer or processor based system, such as a server or the like, which includes a memory 132 storing entity presence application or engine 134 and entity presence profiles 136 for individual entities such as people or users. The entity presence profiles 136 may define individual's attributes. These attributes may include for example presence attributes such as those defined by OMA IMPS (Open Mobile Alliance—Instant Messaging and Presence Services) protocol, including OnlineStatus(S)—indicates if the client device is logged on a presence server; Registration—indicates if the client device is registered in the mobile network; Clientlnfo—information about client, e.g., client model and manufacturer, version of the client; TimeZone—local time zone of the client device; GeoLocation—geographical location of the client device; Address—address of the client device; FreeTextLocation—free text description of the location of the user; PLMN—PLMN code of the network the client device is registered to; CommCap—communication capabilities of the client; UserAvailability(S)—availability of the user for communication; PreferredContacts—contact preferences of the user; PreferredLanguage—language preference of the user; StatusText(S)—user-specified status text; StatusMood—mood of the user; Alias—alias name for the user; StatusContent—media information for the user status; and Contact Info—a vCard for the user. Other presence attributes may also include client device availability (e.g., ON/OFF, busy, etc.), user status (available, unavailable, in meeting, etc.) and so forth.

The entity presence server 130 implements the engine 134 in conjunction with the profiles 136 to provide a presence environment in which presence status of individual entities are tracked; presence information is generated, updated and maintained for individual entities according to respective presence entity profiles; and presence information is provided to other entities or subscribers for example another user through subscription or one time fetch or request which may be subject to appropriate authorization. Further, the entity presence server 130 may employ the presence technology to deliver information to end users and to provide or facilitate the provision of various services.

The various services may include, for example, the following types of applications:

[1] Person-to-person applications. These applications enhance communications between two or more users by providing useful availability information. Such applications may include presence-enhanced contacts; mobile messaging based on presence of a subscriber; self expression, virtual identity, logo service; and mobile gaming in which presence plays a factor.

[2] Content-to-Person applications. These applications enable new kinds of information and content-sharing using presence technology. For example, service and content providers may deliver information to subscriber's communications device (e.g., terminal) in real time accordingly. Such applications may include sport's scores and so forth.

[3] Corporate applications. These applications may enhance employee efficiency and effectiveness. For example, presence information may be integrated with corporate phone book to provide information about availability (e.g., busy) or with the user's corporate calendar so that others will know where the employee or with task list or so forth.

Although individual entity presence allows for the provision of services, this environment reflects presence on an “individual entity” level, but does not reflect presence on a “group” level or offer services or the capability of adding or modifying services to a group or group entity. Accordingly, a group entity presence application or engine is provided herein as a server middleware to implement a group entity presence environment. Such an environment may be of use for groups such as work groups (and their sub-groups) in a corporate or enterprise setting. In this way, a group presence technology may be implemented and enabled to provide group presence information to members of the group or external entity or other subscribing entity; to create, maintain, modify and provide services to groups in the group presence environment such as according to presence information and/or group entity presence profile; and to provide a group channel or communications infrastructure to facilitate flow or sharing or provision of information to and within a group.

As shown in FIG. 1, the group presence server 140 includes a memory 142 storing a group entity presence application or engine 144 and group entity presence profile(s) (e.g., group instance(s)) 146. The group presence server 140, in combination with the engine 144 and the group entity presence profile(s) 146, may be configured to (1) define and update, modify or delete group presence entity profile(s) corresponding to a group of individual entities (or members) such as people or employees or users or objects, etc. and having attributes (e.g., static and dynamic) including for example group presence attributes; (2) obtain presence information for individual entities; (3) manage presence information (e.g., one or more presence statuses—group availability, or other presence-related or -based group information) of one or more such groups according to their defined group presence entity profiles and the presence information for the individual entities; (4) manage or facilitate provision of services to the one or more groups including, for example, the creation, maintenance and update of new services through group presence framework or environment; and (5) manage or facilitate communications of information to or within the group according to the defined group presence entity profile.

The group attributes may include static and dynamic attributes. The dynamic attributes may for example change or be updated according to a change in or to reflect individual or group presence status(es) as well as other group attributes. By way of example, the group attributes may include the following:

[1] Name of the group.

[2] Group logo(s) or other visual or audio characterization of the group.

[3] Group contact methods. Group contact preference and/or contact preference for each group member.

[4] Group location. Location of the group (e.g., all members are at location X in a meeting) or location of each member of the group.

[5] Group Status. This may reflect availability of each member of the group, or all members as a whole (e.g., group is available or unavailable).

[6] Group Communications Availability. This may reflect the availability of each member of the group to communication or all members as a whole to communicate (e.g., group or everyone in the group is available for communication).

[7] Group Device Availability. This may reflect the availability of each of the communications devices of the members (e.g., busy, On/Off, etc.) or the availability of the devices for the group as a whole (e.g., group or at least one device for each member is available).

[8] Information fields. These fields may define content-types which may be provided to members of a group. These information fields may be updated by a member, such as a supervisor of the group, through a communications device (e.g., 110) or through the group presence management system (e.g., 150). Examples of such information may be pertinent or relevant information to the group, such as emergency meeting, group update such as on a particular task, and so forth.

[9] Presence Rules Fields. These fields relate to presence rules which may define conditions or triggering presence states which invoke an action or actions. These fields may be employed by applications to provide services on a group level. These rules may be configured as part of the attributes of a profile or as part of the applications, examples of which are provided below.

[10] Viewpoint Authorization fields. These fields relate to different types of authorization and the information viewpoints available depending on the authorization of a subscriber, such as a member of a group or a defined sub group within a group. Accordingly, different subscribers may have access to different levels of information or information may be filtered according to authorization level of a subscriber. Authorization may be configured according to a subscriber's position in an organizational chart or hierarchy or framework (e.g., High Access—Board of Directors, CEO, etc.; Medium Access—Managers; etc.).

[11] Other group attributes.

The above provide a few examples of group attributes defined with a group entity presence profile for a group. Other group attributes may be defined and utilized depending on the needs of the group or applications/services to be implemented for such groups. It should be understood that attributes as used herein may refer generally to characteristics of the group.

As shown in FIG. 1, the group entity presence server 140 implements the engine 144 in conjunction with the group entity presence profiles 146 to provide a presence environment in which a presence status(es) of group and/or its members are tracked; presence information for the group is generated, updated and maintained according to respective presence entity profiles; presence information or services based on the presence information of the group or its members are provided to the group members or other subscribers. Such information may be provided through subscription or one time fetch or request which may be subject to appropriate authorization. Further, the group entity presence server 140 may employ the group presence technology to deliver information to a group or its members or within a group, and to provide or facilitate the provision of various services to a group or its members.

The various services for a group may include, for example, the following types of applications:

[1] Person-to-Group (or vice versa) applications. These applications enhance communications between members of a group or between a group and an external party by providing useful availability information. Such applications may include sharing of information including messages between particular members of a group and/or with all members of a group.

[2] Content-to-Group applications. These applications enable new kinds of information and content-sharing on a group level using presence technology. For example, service and content providers may deliver information or tailor information for delivery to particular group, such as according to a group interest. As such, information may be targeted and distributed on a group level through group communications infrastructure provided through group presence environment. Such applications may include for example delivering recent news of medical discoveries in surgery to a group of surgeons in a particular hospital or delivering recent news of a newly discovered bird to a group corresponding to a bird watchers club.

[3] Corporate applications. These applications may enhance work group efficiency and effectiveness. For example, presence information for a group may be integrated to deliver information within a work group or sub work groups. The group presence information or that of its members may be employed with corporate information such as corporate organization chart, corporate phone book, calendar or task list of a work group or that of its members to provide information about the availability of a group or its members (versus the whole group), or to track group members or the group as a whole, or so forth. The group information channels may be employed to share or transmit such information to or between members of the group or an external subscriber. Such availability may define for example various availability scenarios or types for a group and their criteria which may be dependent on one or more other group presence status(es) or group attributes. The availability scenarios may include for example availability of the group to accept a new task (e.g., busy, available, etc.), availability of members of the group to accept a new task with respect to the group (e.g., 2 of 11are available, none, etc.), availability of the group to have a meeting (e.g., YES, NO, etc.), etc. Other applications may also utilize other presence attributes or presence status(es). For example, an application may utilize the location of each of the members of the group in combination with a group schedule to track whether everyone in the group has arrived for a particular meeting (e.g., 6 out of 11 members are at the meeting) or estimate how long before all members arrive at a destination.

The above describes a few examples of group level applications or services which may be provided in the group presence environment, described herein. Other applications or services may be created and/or utilized in the group presence environment, depending on the particular enterprise solution desired. There applications or external applications may be integrated to the group presence environment through application interface (API) layer.

The group presence application or engine, as noted above, may be employed as a server middleware for enterprise work group presence solution to provide a system and method to create, maintain and update new services in enterprise/corporate environment, which utilize attributes and opportunities of presence technologies in full scale. This server middleware solution provides a framework through which an owner of a group may create group specific presence instances, besides the use of group members as a buddy list. This would enable utilization of groups as a group specific communication channel, to which group members can subscribe to and still use group in a variety of group services as before. Accordingly, in the operational environment 100, there are presence definitions and statuses for individual members and presence definitions and statuses for group. One or more presence attributes between a group member and a group are not redundant with respect to each other.

The group presence management system 150 may be a computer or terminal which is able to communicate with the group presence server 140 (operating the engine 144) to define, modify or delete group presence entity profiles (e.g., group instances) and their attributes and other group-related data. As noted above, a user such as a supervisor of a group or a current response team member may define a group entity presence profile including defining its attributes such as name of the group entity, logo(s) and other attributes or characteristics relating or not relating to or based on presence (“group presence attributes”). These group presence attributes may include for example their own presence statuses, “confidentiality levels”, application rules for presence status changes, availability rules for a group, preferred types of contacting the group, current availability of group to communicate (within group or with an external entity or user), current availability of group to meet or have a meeting, current availability of group to accept new tasks (e.g., busy, available, etc.), and so forth.

In a corporate context example, the service middleware enables corporations or businesses or organizations to create different work group presence applications according to their specific needs. These services are managed according to the defined group presence entity profile and presence information of the individual entities and may utilize a group communications channel framework provided through group presence environment. Such applications may include for example the following:

[1] Information sharing for members. In this application, presence can be utilized as a communication channel between a group's members to share information for example: upcoming trainings, main organizational news, different kind of events (reserve IIP times, etc.) and meetings of a group.

[2] Availability & Contact information. This application or information would be useful in a corporate, business or organizational context because, for instance, a team (and their manager) can be aware of the availability status (location, presence status ->office, meeting, on sick leave, traveling, etc.) of the team members, can be aware of how to contact them and also can share team related information through an information field (e.g., Info field).

[3] Amount of available members. This application or information would provide an additional quick look of how many members are available for new tasks (e.g. in transportation company).

[4] Availability of Group. This application or information would indicate whether a group is available to take on a new task, is busy on a current task, is almost finished with a current or particular task.

[5] Other group presence related or based applications.

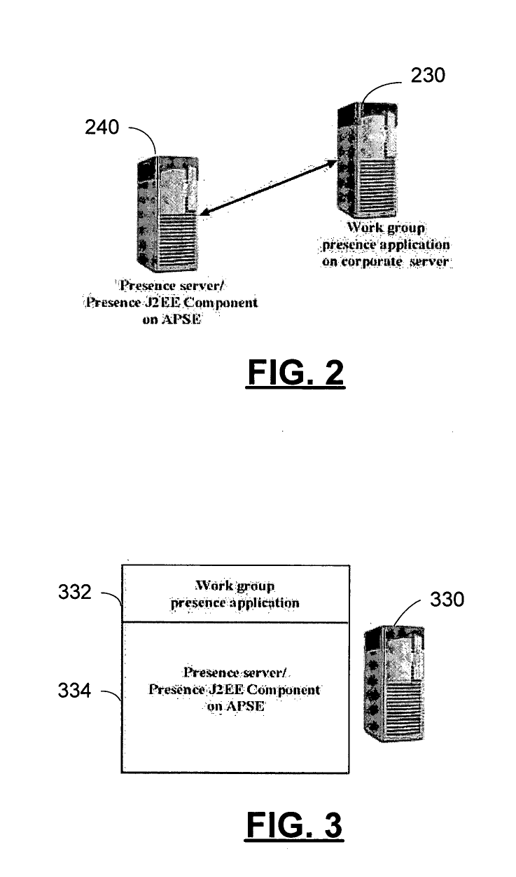

To implement a server middleware for group presence solution, such as in a work group presence in an enterprise setting, various approaches may be employed. One exemplary approach is to embed work group presence application to a server in corporate intranet, which then utilizes external presence server. An example of such an approach is shown in FIG. 2 in which a corporate server 230 implements a work group presence application which utilizes a presence server 240 with a presence J2EE component on APSE. This general configuration is shown by way of example also in FIG. 1. A secondary approach is to develop a separate application on top of an existing presence server or mobility middleware in application server. For example, as shown in FIG. 3, a presence server 330 may implement a work group presence application 332 on top of a entity presence application 334 (e.g., presence server/presence J2EE component on APSE).

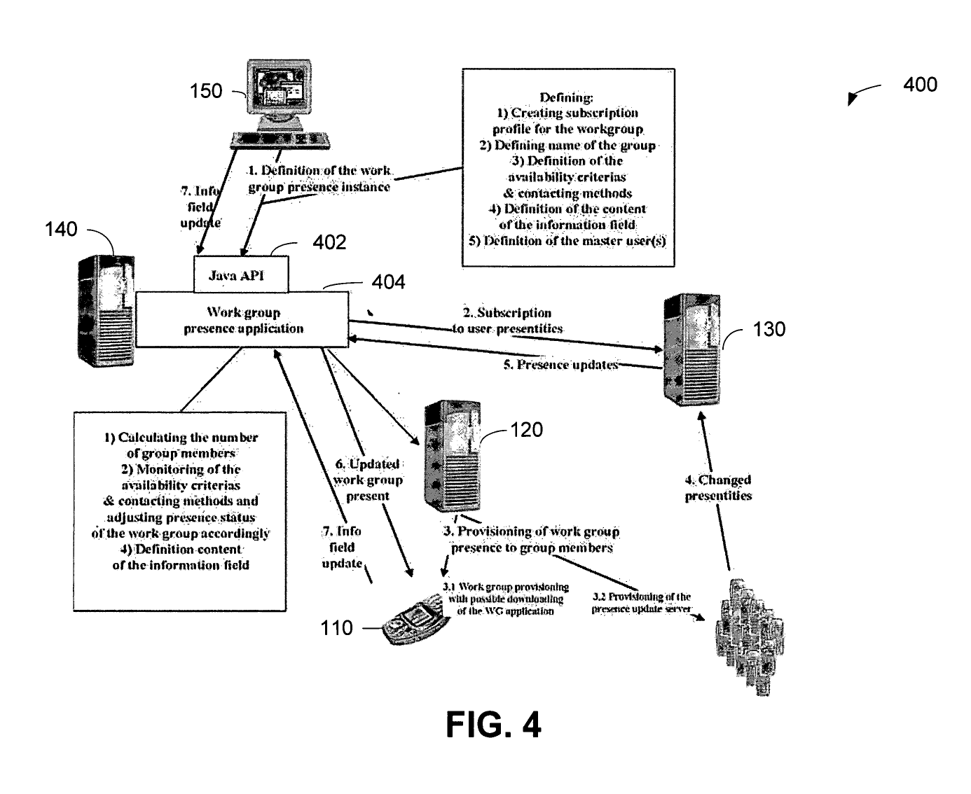

FIG. 4 is a flow diagram of exemplary operations 400 performed by the systems, servers and devices shown in FIG. 1 in accordance with an embodiment. By way of example, the operations 400 will be described with reference to server middleware implementation of work group presence in a corporate or enterprise setting through reference items (1) through (7).

As shown in item (1), the management system 150 cooperates with a workgroup presence application 404 across a java API or other API 404 to manage and configure the work group presence environment. The management system 150 is provided with a tool through which to create subscription profile for a work group within an enterprise and its different groups and subgroups. For this there could be two different options. For instance, respective work groups may utilize predefined work group presence entity profile templates with characteristics or attributes. These may be prepared beforehand by corporate IT function. In this case, groups are readily available for managers, and groups and maintenance is centralized. Alternatively, groups or rather their group presence entity definitions (or instances) can be created by demand and defined as desired. This way also their groupwise characteristics or attributes could be taken into account. These characteristics or attributes may include for example defined name, availability criteria and contacting methods; defined content of the information field, logos etc; defined master user and distribution of different privileged views on groups (e.g., there is possibility to offer more depth to presence statuses for managers of the group if wanted); and so forth.

At item (2), after the work group entity presence profile is defined and stored to the work group presence application 404, the application 404 or the group presence server 140 operating the application 404 subscribes to respective user presence entities (e.g., presenties) of the group.

At item (3), the workgroup presence application 404 operating on the group presence server 140 coordinates with the device management system 120 to provide the communications devices 110 (e.g., terminals) with work group presence applications and/or data. For instance, the communications devices 110 may be provided with work group presence definitions (and with possible downloading of the work group presence application itself to individual terminals) shown with reference to item (3.1) and/or may be provisioned to update their presence status with the presence server 130 shown with reference to item (3.2).

At item (4), the communications device(s) 110 update their statuses to the presence server 130 when a status of any member of the work group changes.

At item (5), the work group application presence application 404 conducts the following operations: stores the definitions for each work group subscriptions; monitors presence status updates from the presence server 130; calculates the number of groups members; and adjust the respective work group presence information when changes occur.

At item (6), the work group application presence application 404 updates the work groups in respect of changes; shares the information field updates to work groups; and updates status of the work group.

At item (7), information field updates can take place directly with the work group presence application 404 operated by the server 140 through the management system 150 of the work group presence application or a communications device 110 or other device operated by a user of the group such as one of the group managers.

As shown in FIG. 4, a Java API or other API 402 may be provided on top of or generally as an interface to work group presence application 402 to enable application developers, such as third party developers, to utilize the possibilities to introduce new functionalities and linkages to attach the group presence application or technology or environment to larger mobility middleware service developments (e.g. web services, authentication etc.). Third party developers can include SIs (Service Integrators), operators offering enterprise services, ISVs (Independent Software Vendors), etc.

Accordingly, the provision of a middleware group presence application enables and/or facilitates new class of presence services such as for enterprises, where the IT personnel of the enterprise can modify the work group presence service to match their specific needs according to their business type and organization structure.

The middleware group presence application provides among other things benefits and advantages such as: enterprises can define their work group presence applications according to their inherent needs; work group presence could be predefined to reflect organizations structure; there could be different views according to groups' members place in organizations hierarchy (managers could have more depth in their views, employees could see relevant information for their work); information can be transmitted or sent about the relevant issues to the group; utilization of groups as a group specific communication channel is enabled; groups can define their own presence statuses and reflect through then the groups availability to new work items; a group can monitor it's own status, e.g. who is available now; and a work group presence application can be included or incorporated as a part of enterprises IT network (Intranet).

The group presence implementation is provided as an example. Group presence may be implemented in other contexts, with other component configurations (e.g., presence server arrangement as in FIG. 3), with other or modified operations, and so forth to provide a group presence environment. Further, the work group presence application 404 in FIG. 4 is shown as being implemented as server middleware, but may if desired be implemented in a communications device 110 such as a mobile terminal of a user or subscriber depending on the desired properties of the work group presence application.

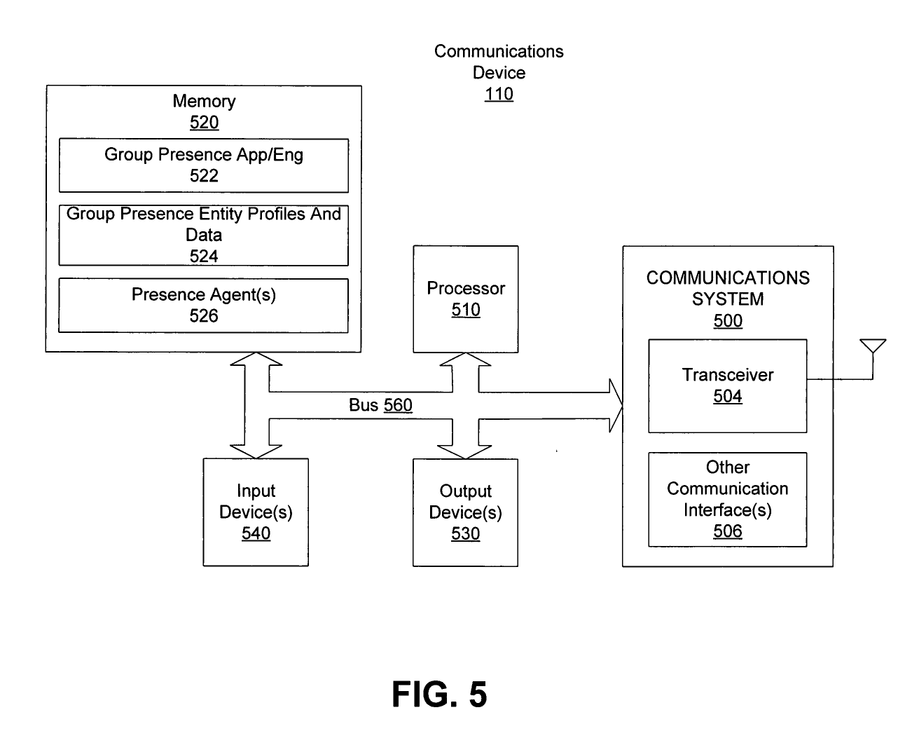

FIG. 5 is a block diagram showing exemplary components of a communications device 110 in accordance with an embodiment. As shown, the device 110 may generally include one or more processor(s) 510, a memory 520, input device(s) 540, output device(s) 530, a communications system 500, connected across one or more buses 560. In addition, each of these components is coupled to a power source, such as a rechargeable battery (not shown).

The processor(s) 510 control the various operations and functions of the user device, including general operation of the device 110 as well as implementation of features of group presence and individual entity presence features described herein. These features may involve transmission of update information including updated information field data, presence update data, or other information; reception of application downloads or data to implement presence features and of group and individual presence information (or services). The processor(s) 510 may include one or more microprocessors that are each capable of executing software instructions or computer executable code stored in memory 520.

The memory 520 may include random access memory (RAM), read only memory (ROM), and/or flash memory or other tangible memory medium, and stores information in the form of data and software components (also referred to herein as modules). These software components include instructions or code that can be executed by the processor(s) 510, such as to perform the various features described herein. Various types of software components may be stored in the memory 520. For instance, the memory 520 may store software components that control the operation of components of the user device, such as the communications system 500, input device(s) 540, and output device(s) 530.

In one aspect, the memory 520 may also store software components that manage or facilitates management or control of presence information of a group, such as generally described herein. These components may include group presence application or engine 522, group presence entity profile and data 524 and presence agents 526 for updating individual entity presence or other group related information (e.g., information field). As described above with reference to FIG. 4, the engine 522 and/or the profile and data 524 may be downloaded to the device 110 from a presence-type server (e.g., 140).

The input device(s) 540 may include one or more devices that allow a user to input information. Examples of such devices include keypads, touch screens, and microphones. The output device(s) 530 may include various devices, such as a display, and one or more audio speakers. Exemplary displays include liquid crystal displays (LCDs), and video displays.

The communication system 500 may include a transceiver 504 to transmit and receive information or data such as through wireless communications, and other communication interface(s) 506 including for example serial or parallel or USB connection or network interface or so forth. The communication system 200 may be configured to conduct communications including mobile or wireless communications such as and/or messaging such as short message service (SMS), multimedia messaging system (MMS) or electronic mail (email).

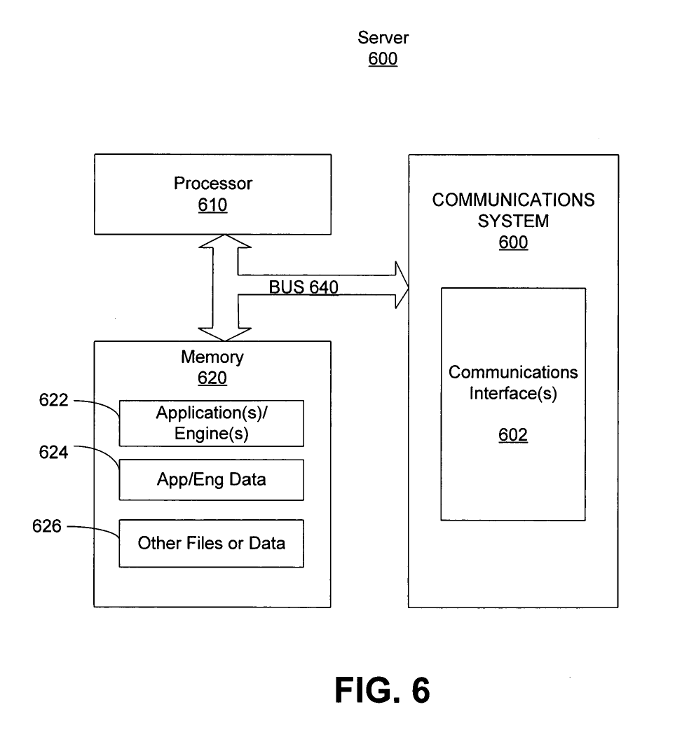

FIG. 6 is a block diagram showing exemplary components of a server (or system) 600 in accordance with an embodiment. The servers 130, 140 and the system 120 of FIG. 1 may generally be configured like the server or system 600.

The server 600 includes processor(s) 610, communications system 600 and memory 620, which are coupled across one or more buses 640. The communications system 600 includes communication interface(s) 602 such as a network interface and other communications components to enable communications with other parties or entities across one or more networks, such as the Internet, Wide Area Network (WAN), etc.

The processor(s) 610 control the various operations and functions of the server, for example, entity presence feature, group entity presence feature and/or device management of communications devices (e.g., 110), as described herein. The processor(s) 610 may include one or more microprocessors that are each capable of executing software instructions or computer executable code stored in memory 620.

The memory 620 may include random access memory (RAM), read only memory (ROM), and/or flash memory or optical drives or hard drives or other tangible memory medium, and stores information in the form of data and software components (also referred to herein as modules). These software components include instructions or code that can be executed by processor(s) 610. Various types of software components may be stored in memory 620. For instance, memory 620 may store software components or an operating system that control the operation of components of the server 620. These software components may includes application(s)/engine(s) 622, application(s)/engine(s) data 624 and other files or data 626.

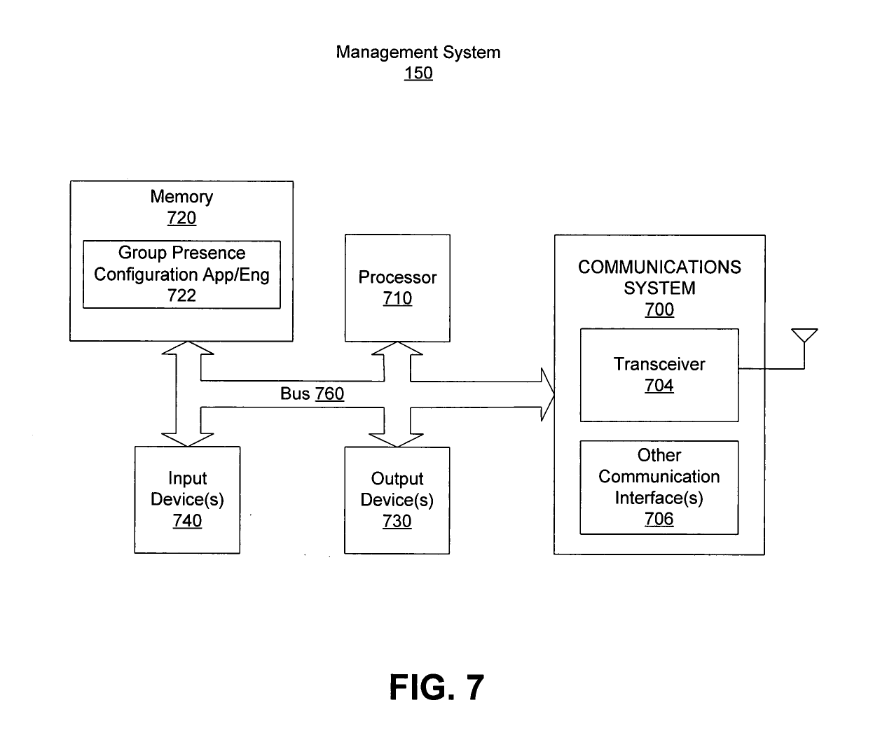

FIG. 7 is a block diagram showing exemplary components of a management system 150 in accordance with an embodiment. As shown, the system 150 may generally include one or more processor(s) 710, a memory 720, input device(s) 740, output device(s) 730, a communications system 700, connected across one or more buses 760. The system 150 may include a fixed or removable rechargeable power supply connectable to an external power source (not shown).

The processor(s) 710 control the various operations and functions of the system 150, including general operation of the device 150 as well as implementation of features of cooperating with a group entity presence application or server implementing such application to define group entity presence profile for a group including defining attributes or characteristics thereof. Examples of such profile and attributes are described above with reference to FIG. 1. Other operations may also include updating of an information field for a group or other group related information to the group entity presence application or the like. The processor(s) 710 may include one or more microprocessors that are each capable of executing software instructions or computer executable code stored in memory 720.

The memory 720 may include random access memory (RAM), read only memory (ROM), and/or flash memory or other tangible memory medium, and stores information in the form of data and software components (also referred to herein as modules). These software components include instructions or code that can be executed by the processor(s) 710, such as to perform the various features described herein. Various types of software components may be stored in the memory 720. For instance, the memory 720 may store software components that control the operation of components of the user device, such as the communications system 700, input device(s) 740, and output device(s) 730. As shown, the memory 720 includes group presence configuration application or engine 722 for defining group entity presence profile.

The input device(s) 740 may include one or more devices that allow a user to input information. Examples of such devices include keypads, touch screens, and microphones. The output device(s) 730 may include various devices, such as a display, and one or more audio speakers. Exemplary displays include liquid crystal displays (LCDs), and video displays.

The communication system 700 may include a transceiver 704 to transmit and receive information or data such as through wireless communications, and other communication interface(s) 706 including for example serial or parallel or USB connection or network interface or so forth. The communication system 700 may be configured to conduct communications including mobile or wireless communications such as and/or messaging such as short message service (SMS), multimedia messaging system (MMS) or electronic mail (email).

The above FIGS. 5 through 7 are simply examples of the communications device, servers, systems and their components. These device, servers and systems may be configured in other manners with different components or component arrangements to perform the various features described herein.

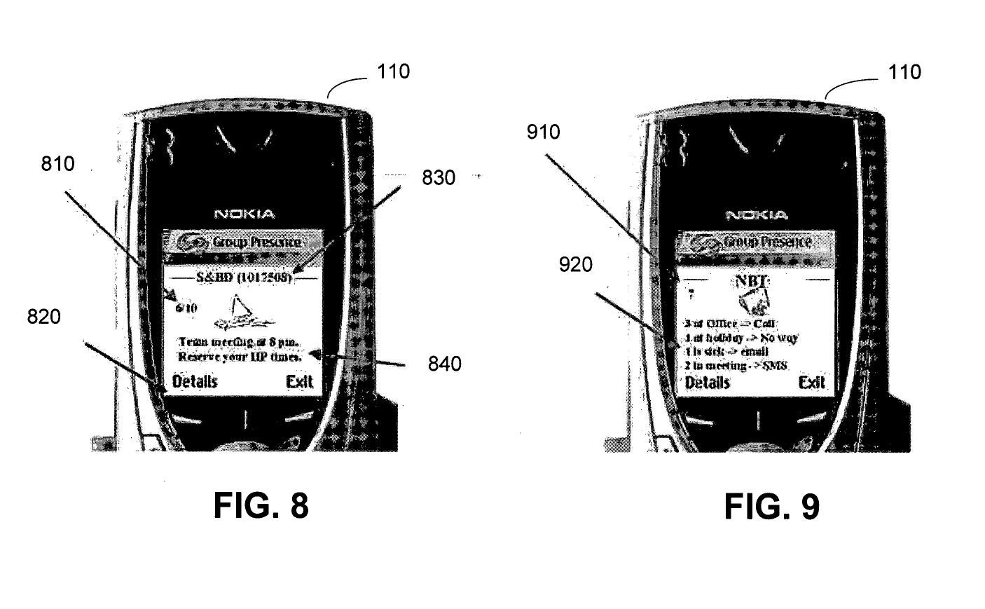

FIGS. 8 and 9 show exemplary screen shots of exemplary information provided on a communications device (e.g., 110) of a group member or entity through a group presence environment, such as provided through server middleware, in accordance with an embodiment. As shown in FIG. 8, a communications device 110 displays an amount of available group members, e.g., 6/10 or six available members out of 10 members in the group, identified by reference numeral 810. Availability can have different definitions as desired. The device 110 further displays a name of the group, e.g., S&BD (1017508), identified by reference numeral 830; details for the group (e.g., group presence information and group member information) identified by reference numeral 820; and information for the group (instead of presence status, e.g., swimming, general information for the group may be shown) identified by reference numeral 840.

As shown in another example in FIG. 9, a communications device 110 can also display an amount of group members, e.g., 7 or seven members, identified by reference numeral 910 and information about the availability of the group and preferred contacting methods identified by reference numeral 920.

FIGS. 8 and 9 provide examples of the type of information which may be provided and displayed on a communications device of a subscriber or member of a group. Other group information, e.g., presence or general information for the group, may also be transmitted and displayed on the communications device.

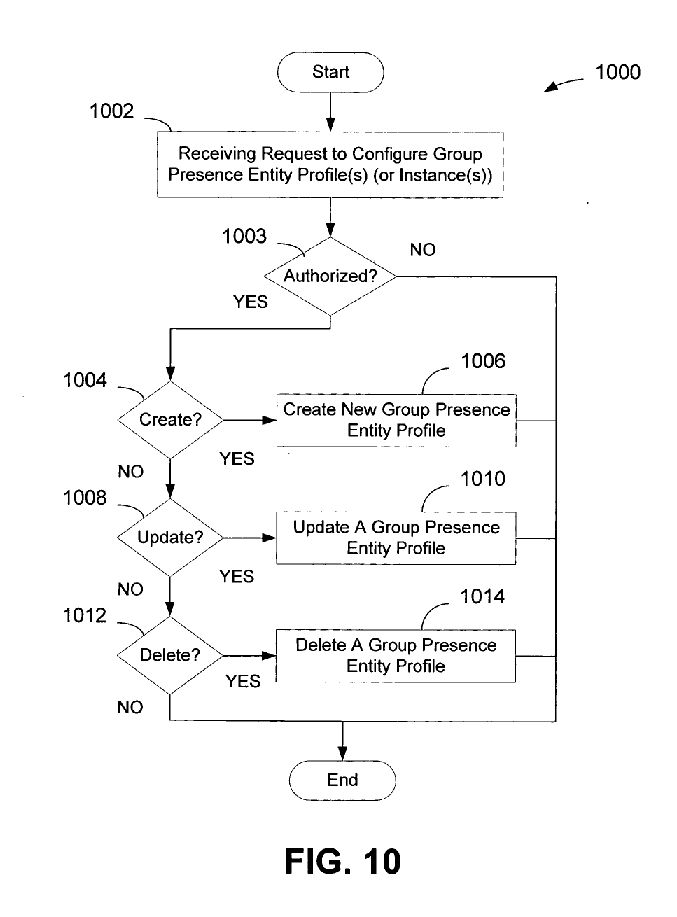

FIG. 10 is a flow diagram of an exemplary process 1000 to define group presence entity profile in accordance with an embodiment. By way of example, the process 1000 will be described with reference to group presence server 140 (operating the group entity presence application or engine 144) and the group presence management system 150 of FIG. 1.

At step 1002, the group presence server 140 receives a request to configure group presence entity profile(s) (or instance(s)), such as from the group presence management system 150. At step 1003, the group presence server 140 determines whether the request is authorized, e.g., whether the requester is authorized to configure group presence entity profile(s). If not, the process 1000 terminates.

If authorized, the group presence server 140 determines whether the request is to create a new profile at step 1004. If so, the group presence server 140 creates a new group presence entity profile and stores the profile at step 1006. For example, a user such as a supervisor or team leader of a group may interact with the group presence server 140 to define a new group presence entity profile as well as its attributes through the group presence management system 150. Various examples of such attributes are described above including the name, members, availability status and so forth. The user may create a new profile for a group using a profile template or form having predefined fields such as attribute fields, or may customize one or more aspects of a profile such as define unique attributes or select attributes from a list of predefined attributes for a group. Once the profile has been defined, the process 1000 terminates.

Turning back to step 1004, the process 1000 proceeds to step 1008 if the request is not to create a new group presence entity profile. At step 1008, the group presence server 140 determines whether the request is to update (or modify) an existing group presence entity profile. If so, the group presence server 140 modifies the particular group presence entity profile or one or more of its attributes or other data. For example, a user such as a supervisor of a group or a team leader may interact with the group presence server 140 to update or modify a particular group presence entity profile as well as its attributes through the group presence management system 150. The user may for instance wish to add or delete a member or modify members contact info, to add or delete or modify information field and so forth. Once the profile has been modified, the process 1000 terminates.

Turning back to step 1008, the process 1000 proceeds to step 1012 if the request is not to update a group presence entity profile. At step 1012, the group presence server 140 determines whether the request is to delete a particular group presence entity profile. If not, the process 1000 terminates. Otherwise, if the request is to delete a particular profile, then the group presence server 140 deletes the particular profile at step 1014. For example, a user such as a supervisor of a group or team leader may interact with the group presence server 140 to delete a particular group presence entity profile through the group presence management system 150. The user may for instance wish to delete a profile when the group becomes obsolete such as after reorganization of a corporation, a division or the like. Once the profile has been deleted, the process 1000 terminates.

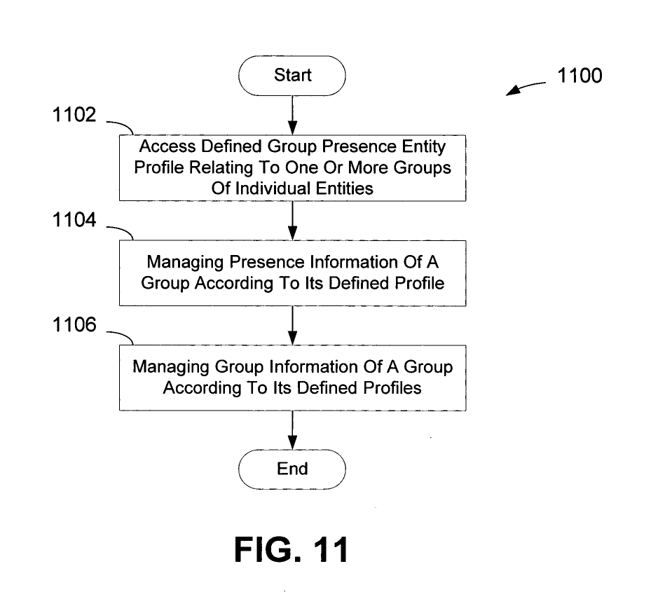

FIG. 11 is a flow diagram of an exemplary process 1100 to manage services in a group presence environment in accordance with an embodiment. By way of example, the process 1100 will be described with reference to group presence server 140 (operating the group entity presence application or engine 144) of FIG. 1.

At step 1102, the group presence server 140 access defined group presence entity profile of one or more groups of individual entities or members. At step 1104, the group presence server 140 manages presence information of a group according to its defined group presence entity profile. Presence information may for example include for example availability information for a group or other information related to presence status of the group or its members. At step 1106, the group presence server 140 manages group information of a group according to its defined group presence entity profile. Group information may include for example general information for the group which may include non-presence based information, such as in general messages or other information relevant to the group (e.g., emergency meeting, news, etc.) which may be distributed within the group or between members of the group through the group presence channel provided in the presence environment. Such information however may be delivered based on the presence information (or status) of the group or its members according to the group presence entity profile (e.g., group communications availability and preferred contact, authorization levels, communications availability of group members and/or preferred contact, etc.).

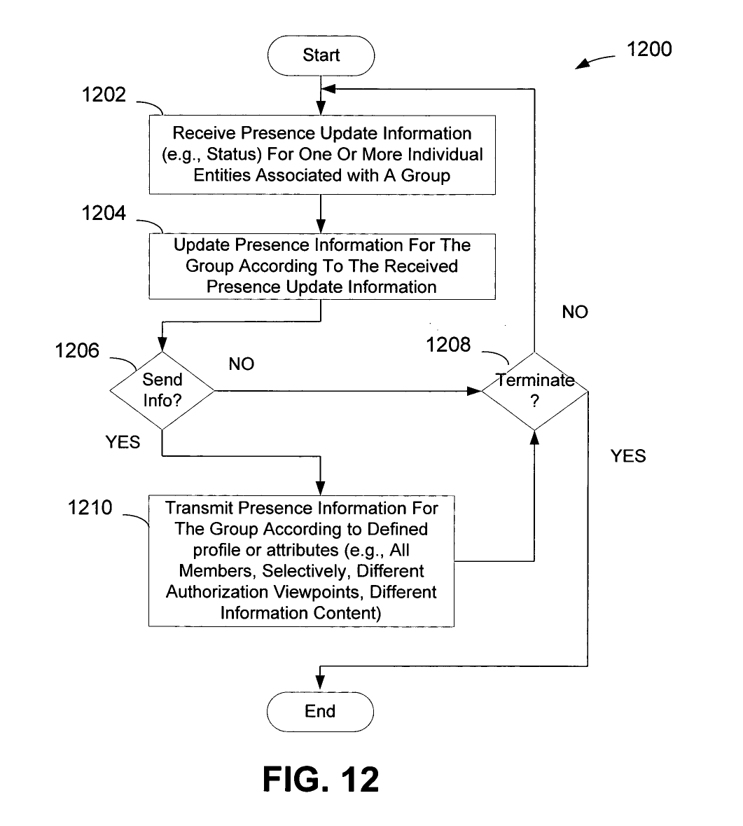

FIG. 12 is a flow diagram of an exemplary process 1200 to manage presence information for one or groups in accordance with an embodiment. By way of example, the process 1200 will be described with reference to group presence server 140 (operating the group entity presence application or engine 144) of FIG. 1.

At step 1202, the group presence server 140 receives presence update information (e.g., status) for one or more individual entities or members of a group. This may be obtained through a subscription of presence information or an individual request for such information. At step 1204, the group presence server 140 updates presence information for the group according to the presence update information of the one or more individual entities or member and the group presence entity profile. At step 1206, the group presence server 140 determines whether to send the presence information to one or more subscribers, such as to members of the group or an external party. Such information may be available to authorized subscribers or requesters. If the presence information of the group is not sent, then the process 1200 proceeds to step 1208 to determine whether to terminate. If not, the process proceeds back to step 1202 to receive more updates. Otherwise, if so, the process terminates.

If the presence information is to be sent (e.g., to authorized subscribers or requesters), then the group presence server 140 transmits presence information for the group according to defined profile or its attributes. For instance, the profile may include attributes which define or are factors that define how or what information is to be distributed under particular circumstances, such as to all members (shared), selective viewpoints to different members or subscribers according to authorization level or the like, and so forth. Thereafter, the process 1200 proceeds to step 1208 to determine whether to terminate. If not, the process proceeds back to step 1202 to receive more updates. Otherwise, if so, the process terminates.

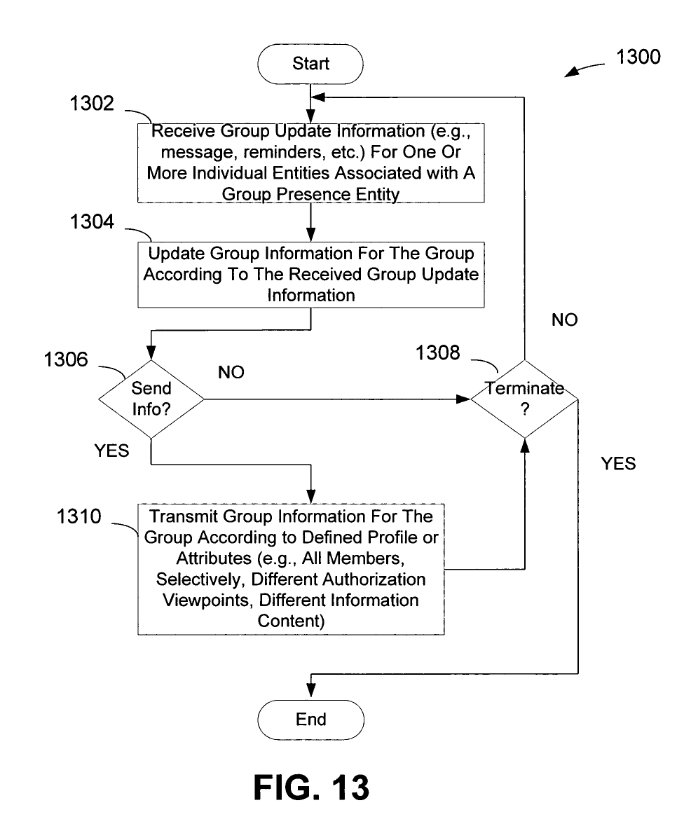

FIG. 13 is a flow diagram of an exemplary process 1300 to manage group information or services for one or more groups in accordance with an embodiment. Group information may simply be general information for a group and may be provided as part of an integration of applications or services of distribute various kinds or types of information to a group depending on the group presence or presence of its members. By way of example, the process 1300 will be described with reference to group presence server 140 (operating the group entity presence application or engine 144) of FIG. 1.

At step 1302, the group presence server 140 receives group update information (e.g., messages, reminders, etc.). The group update information may be received from one or more individual entities or members of a group or an authorized member such as through an information field update. This information may also be received from a source external to the members of the group, e.g., some entity with a higher authority or a content or service provider or external application, and so forth. At step 1304, the group presence server 140 updates group information for the group according to the received group update information and the group presence entity profile. At step 1306, the group presence server 140 determines whether to send the group information to one or more subscribers, such as to members of the group or an external party. Such information may be available to authorized subscribers or requesters. If the presence information of the group is not sent, then the process 1300 proceeds to step 1308 to determine whether to terminate. If not, the process proceeds back to step 1302 to receive more updates. Otherwise, if so, the process terminates.

If the group information is to be sent (e.g., to authorized subscribers or requesters), then the group presence server 140 transmits group information for the group according to defined profile or its attributes. For instance, the profile may include attributes which define or are factors that define how or what information is to be distributed under particular circumstances, such as to all members (shared), selective viewpoints to different members or subscribers and so forth. The attributes may be presence status of the group or its members or communications availability or preferences for the group or its members. Thereafter, the process 1300 proceeds to step 1308 to determine whether to terminate. If not, the process proceeds back to step 1302 to receive more updates. Otherwise, if so, the process terminates.

The above describes processes, such as in FIGS. 10-13, may be implemented or controlled by software including firmware through one or more processors or one or more hardwired or integrated circuits or a combination thereof. The software implementation may take the form of a tangible medium having computer executable code which when read and executed by one or more processors performs the processes described above and herein. These processes are provided as a few examples. The processes are not limited to the described operations or order of operations which can be modified to perform the various functions described herein. Further, the processes may be implemented through a distributed presence arrangement such as shown in FIGS. 1 and 2 or through an application arrangement shown in FIG. 3.

While various embodiments of the present invention have been described above, it should be understood that they have been presented by way of example only, and not in limitation. Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents. Thus, other network types are within the scope of the present invention.

What is claimed is:

1. A method comprising:
defining a group presence profile for a group of individual entities, the group presence profile having group attributes associated therewith;
obtaining presence information for the individual entities of the group; and
managing presence information for the group according to the defined group presence profile and the presence information of the individual entities.

2. The method according to claim 1, wherein the presence information for the group is shared with the individual entities of the group according to the defined group presence profile.

3. The method according to claim 1, wherein the presence information includes one or more viewpoints of information accessible according to an authorization level of a viewing entity.

4. The method according to claim 1, further comprising:
enabling an external entity to access the presence information of the group.

5. The method according to claim 1, wherein the managing operation comprises:
generating or updating the presence information for the group according to the accessed presence information of the individual entities and respective defined group presence profile.

6. The method according to claim 1, wherein the managing operation comprises:
generating or updating the presence information for the group according to update information provided by a member of the group.

7. The method according to claim 1, further comprising:
providing the group presence profile and corresponding attributes to a communications device of an individual entity of the group.

8. The method according to claim 1, further comprising:
providing an application program to a device operated by an individual entity of the group, the application program when executed enables the device to perform the managing operation.

9. The method according to claim 1, wherein the defining and managing operations are implemented through a server middleware application program.

10. The method according to claim 9, further comprising:
providing an application interface (API) for interfacing an external application with the server middleware application program.

11. The method according to claim 1, wherein the individual entities correspond to people in an organization.

12. The method according to claim 1, further comprising:
updating one or more attributes of the group presence profile.

13. The method according to claim 1, wherein the attributes of the group presence profile define one or more categories of presence information to be obtained for the group.

14. The method according to claim 13, wherein the one or more categories of presence information include at least an availability status of the group.

15. The method according to claim 1, further comprising:
managing one or more services provided to the group according to the presence information of the group.

16. The method according to claim 15, wherein the one or more services comprises distribution of information within the group.

17. The method according to claim 1, further comprising:
managing communications of information within the group according to the defined group presence profile or presence information of the group.

18. A system comprising:
one or more processors for defining a group presence profile for a group of individual entities, the group presence profile having group attributes associated therewith, obtaining presence information for the individual entities of the group; and managing presence information for the group according to the defined group presence profile and the presence information of the individual entities.

19. The system according to claim 18, wherein the presence information for the group is shared with the individual entities of the group according to the defined group presence profile.

20. The system according to claim 18, wherein the presence information includes one or more viewpoints of information accessible according to an authorization level of a viewing entity.

21. The system according to claim 18, wherein the one or more processors further enables an external entity to access the presence information of the group through application program interface (API).

22. The system according to claim 18, wherein the one or more processors perform the managing operation by generating or updating the presence information for the group according to the accessed presence information of the individual entities and respective defined group presence profile.

23. The system according to claim 18, wherein the one or more processors perform the managing operation by generating or updating the presence information for the group according to update information provided by a member of the group.

24. The system according to claim 18, wherein the one or more processors controls provision of the group presence profile and corresponding attributes to a communications device of an individual entity of the group.

25. The system according to claim 18, wherein a communications device operated by an individual entity of the group is provided with an application program which when executed by the device performs the managing operation.

26. The system according to claim 18, further comprising memory for storing a server middleware application program which when executed by the one or more processors performs the defining and managing operations.

27. The system according to claim 26, wherein the memory further stores an application program interface to enable external application to interface the server middleware application program.

28. The system according to claim 18, wherein the individual entities correspond to people in an organization.

29. The system according to claim 18, wherein the one or more processors control update of one or more attributes of the group presence profile.

30. The system according to claim 18, wherein the attributes of the group presence profile define one or more categories of presence information to be obtained for the group.

31. The system according to claim 30, wherein the one or more categories of presence information include at least an availability status of the group.

32. The system according to claim 18, further comprising:
managing one or more services provided to the group according to the presence information of the group.

33. The system according to claim 32, wherein the one or more services comprises distribution of information within the group.

34. The system according to claim 32, wherein the one or more processors further manage communications of information within the group according to the defined group presence profile or presence information of the group.

35. A computer readable medium having computer executable code which when executed by a processor performs the following method:
defining a group presence profile for a group of individual entities, the group presence profile having group attributes associated therewith;
obtaining presence information for the individual entities of the group; and
managing presence information for the group according to the defined group presence profile and the presence information of the individual entities.
